(19) United States
(12) Patent Application Publication
(10) Pub. No.: US 2005/0211607 A1
(43) Pub. Date: Sep. 29, 2005

(54) Sedimentation basin

(76) Inventor: Martin Armbruster, Karlsruhe (DE)

Correspondence Address: DAVID A. GUERRA, 933 OLANDER WAY SOUTH, SUITE 3, SOUTH PASADENA, FL, 33707, US

(21) Appl. No.: 10/509,532

(22) PCT Filed: Mar. 19, 2003
(86) PCT No.: PCT/EP03/02839

§ 371 Date: May 16, 2005

(30) Foreign Application Priority Data
Apr. 4, 2002 (DE) 102 14 963.1
Oct. 2, 2002 (EP) 02022051.3

(51) Int. Cl. B01D 21/24

(52) U.S. Cl. 210/97; 210/137; 210/519; 210/521

(57) ABSTRACT

A separation level is formed between the heavy phase and the light phase in a gravitational sedimentation basin. In the case of a centrally arranged inlet construction, said inlet has a substantially horizontally cross-flown cross-section, whereby the level of said cross-section can be continuously adapted to the separation level. Optionally, the vertical dimension of the cross-section of the inlet can also be adjusted. The inlet can also be arranged on the edge, where it can be adapted to the separation level either continuous or in stages. By adaptively adjusting the inlet, the mixing behavior of the suspension flow is improved, whereupon the separation performance of the sedimentation basin and the discharge quality is also improved.

The invention relates to a sedimentation basin for a two-phase suspension, particularly for sewage sludge, in which the denser and therefore heavier phase settles downwards by gravitational separation, resulting in the formation of a separation level between the heavy phase and the light phase.

Nowadays gravitational sedimentation basins are used worldwide as standard constructions for solid/fluid separation in biological purification stages of sewage treatment works. Despite decades of research work in this field, these constructions do not function in an optimal manner. Their separation performance is unsatisfactory in relation to the space which is available to them for this purpose. Also the discharge values of the lighter phase which is to be clarified are frequently unsatisfactory. This is the case in particular when the inlet lies above the separation level. The separation level is defined as the level from which the concentration in the sedimentation basin rises with a high gradient from the residue of the lighter phase to the heavier phase. The discharge value or discharge quality is defined as the residual quantity of heavy phase to be separated off in the discharge of the light phase to be clarified or vice versa. Because of the known problems with sedimentation basins there are numerous publications which deal with optimization of these constructions. They contain repeated references to the dominant influence of the inlet construction.

According to the laws of physics of dense flows, dense flows suck in fluid from the ambience over their edges. The extent to which this sucking in takes place is directly dependent upon how high the total energy is which the flow has at its entry into the ambient fluid. This sucking in of ambient fluid which increases the transported volume flow and mass flow in the dense flow is called entrainment. A volume flow Q grows by entrainment on its flow path from the inlet volume flow Qᵢ to an increased volume flow Q=Qᵢ+ΔQ. Since sedimentation basins fulfil their function all the more efficiently the smaller Q is, any measure which reduces the energy of the in-flowing suspension at the inlet increases the efficiency of the sedimentation basin.

The entrainment behavior of a dense flow can be influenced technically only over a limited area, the so-called near field of the technical construction; in the far field of the construction the entrainment is produced from the locally prevailing physical parameters of density difference between the local density ρᵢ and the density of the ambience ρₐ, the local pressure gradient, the thickness h_{D} of the dense flow and consequently its local velocity.

The total energy present at the inlet can be written as the sum of its individual components:
Eₜₒₜ=(Eₚₖ)ₘᵢₙ+E_{b}+ΔEₚₖ+ΔE_{U}

The inlet area Aᵢ of an inlet construction which is flowed through horizontally can be calculated at Aᵢ=hᵢ·bᵢ in case that the height hᵢ of the inlet cross-section remains constant over the inlet width bᵢ. The volume flow per inlet width is qᵢ=Qᵢ/bᵢ, the average inlet velocity is Uᵢ=qᵢ/hᵢ.

If the local energy Eₜₒₜ=(Eₚₖ)ₘᵢₙ+ΔE is higher by an energy surplus ΔE=E_{b}+ΔEₚₖ+ΔE_{U} than the minimum necessary energy (Eₚₖ)ₘᵢₙ in order to move a dense flow with a given volume flow Q, this leads to entrainment. According to the physical least-energy principle, for sedimentation basins (Eₚₖ)ₘᵢₙ is established when the densimetric Froude number is Fr_{D}=Uᵢ/(g′·hᵢ)^{1/2}=1 with simultaneously the widest possible inlet and the inlet lies at the separation level. The gravitation constant g′ which is actually effective locally results from the difference between the local density ρ₁ and the density of the ambience ρₐ as g′=(ρ₁−ρₐ)/ρₐ·g.

E_{b} is the amount by which the energy surplus ΔE at the inlet increases if the inflow does not take place at the height of the separation level.

If a suspension of density ρₛ is introduced below the separation level situated at the height hₛ at a vertical distance h₀ from the point of equal density of the ambient phase into an ambient phase of higher density, because of its lower density it has a buoyancy energy E_{b} and is consequently deflected upwards from the horizontal at the angle Φ. The deeper the introduction is below the separation level the greater therefore is the buoyancy energy E_{b} and consequently the rate of entrainment. From the energy point of view these considerations give rise to the requirement to configure the inlet into a sedimentation basin so that the lifting energy for fluctuating heights hs of the separation level is minimized by adaptation of the relative height h₀ of the inlet surface just below the separation level with h₀≈0 and thus E_{b}≈0.

ΔEₚₖ is the amount by which the energy surplus ΔE at the inlet increases if the optimal relationship of kinetic and potential energy with Fr_{D}=1 is not present. The inlet height hᵢ which is optimal in energy terms is hᵢ=(q₁²/g′)^{1/3} with Fr_{d}=1. Thus for variable inlet conditions the Froude number can be controlled by adaptation of the height hᵢ of the inlet.

ΔE_{U} is the amount by which the energy surplus ΔE at the inlet increases if the width bᵢ of the inlet is smaller than the maximum possible width. By geometric consideration the maximum possible width is produced with the technical feature of an inlet disposed around the periphery.

The entrainment can have a positive effect on the discharge values of a sedimentation basin when it ensures at the inlet of the suspension that the incoming suspension is to a limited extent enriched with suspension of a higher density from the sedimentation basin and thus the larger flocks of the ambient suspension can hold back smaller particles of the intake suspension and thus a so-called flock filter effect takes place. This Flock filter effect is a desirable process which is demanded for example in dimensioning rules for secondary sedimentation basins.

Flows in sedimentation basins may be distinguished according to their flow direction as source or sink flows. In source flows the fluid is continuously retarded on the flow path by constantly increasing pressure, and in sink flows the fluid is continuously accelerated by constantly falling pressure. A sink flow travels in a substantially more stable fashion and consequently is markedly less susceptible to disturbances. Disturbances are caused in sedimentation basins by flow rates Uᵢ at the inlet which vary over time. These disturbances impose pulse forces on the stratified fluid body which are proportional to the rate Uᵢ. In the case of a central inlet Uᵢ is very great and the resulting great destabilizing disturbances are superimposed on a flow which is in any case unstable. In the case of a peripheral inlet the rate Uᵢ is markedly less and thus the pulse force is drastically reduced and moreover is superimposed uncritically on a stable flow.

The phenomenon that the entrainment decreases as h₀ becomes less and therefore the buoyancy energy E_{b} becomes less is utilized in the method described in the patent DE 197 58 360 C2 and the corresponding publication EP 0 923 971 A1 in which h₀ is minimized in stages at a central inlet construction for round sedimentation basins. A minimization of ΔEₚₖ and ΔE_{U} is not considered here. Thus the entrainment phenomenon can be reduced, but remains present to a significant extent. However, adaptation of the height h₀ of the inlet in stages is seen as very critical for a central inlet construction, since when a stage is started and taken out of operation the adaptation imposes very discontinuous flow rates and thus particularly destabilizing pulses on a source flow which is physically unstable in any case. This leads potentially to markedly poorer discharge qualities.

The phenomenon that the entrainment decreases as bᵢ becomes greater and thus the energy ΔE_{U} becomes less is utilized for example in the method described in the publication DE 198 30 311 A1, in which the inlet is disposed peripherally, that is to say at the edge of the sedimentation basin, near the floor. A minimization of ΔEₚₖ is not considered here and E_{b} is actually maximized by placing the inlet near the floor. Thus the disturbing effect of the entrainment is also retained to a large extent in this case.

Patent Abstracts of Japan Vol. 008 No. 077 (C-218), i.e. JP 59 004 407 A, and Patent Abstracts of Japan Vol. 2000 No. 14, i.e. JP 2000 325706 A, disclose a variable inlet construction for a sedimentation basin which makes it possible that for all layers of the separation level within the sedimentation basin the upper edge of the inlet lies as high as possible but always below the separation level. However, no suitable structural measures are provided which force the incoming volume flow into a horizontal flow direction. Rather, the incoming suspension flows through a vertical cylinder which is adjustable in height in a predominantly vertical flow direction past the height-adjustable lower edge of the inlet cylinder into a greater depth. The actual level of the turning point at which the vertically downwardly directed flow of the suspension becomes a horizontal flow direction, and thus the inlet height which determines the resulting lifting energy, is not controlled technically in these previously known inlet constructions. There is no defined inlet surface for the horizontal inlet flow. In this previously known constructions the actual level of the transition between vertical and horizontal flow direction is produced according to physical laws exclusively as a function of the balance of a downwardly directed pulse force by flow velocity on the one hand, and an upwardly directed buoyancy force which the downwardly flowing inlet jet is subjected to by ever increasing ambient density.

In view of the described disadvantages in the prior art, the technical problem is posed of proposing an optimized sedimentation basin which is distinguished by higher separation performance, better discharge plant, lower internal loading and operation with little disturbance.

The present invention is based on the recognition that not only destabilizing pulses but also the inlet energy
Eₜₒₜ=(Eₚₖ)ₘᵢₙ+E_{b}+ΔEₚₖ+ΔE_{U}
must be decreased as far as possible at the inlet or must be reduced to the technically possible minimum. Thus the entrainment which is dependent upon the inlet energy is also reduced with the highest possible stability of the flow.

In a sedimentation basin with a centrally disposed inlet construction with at least one suspension supply line and at least one inlet which is adjustable in height and opens into the sedimentation basin in the region of the separation level, this object is achieved according to claim 1 in that the inlet has an inlet cross-section which is flowed through substantially horizontally and of which the relative height h₀ can be adapted continuously to the respective height hₛ of the separation level. By the provision of an inlet surface which is flowed through horizontally with a defined upper and lower edge it is possible to adjust the effective height of the inlet flow for each operational state so that the input of energy at the inlet is minimal.

The object is also achieved by a sedimentation basin in which according to claim 7 the inlet is disposed at the edge of the sedimentation basin and the relative height h₀ of the inlet can be adapted to the respective height hₛ of the separation level.

If in a central inlet construction the adaptation of the relative height h₀ of the incoming flow to the respective height hₛ of the separation level takes place continuously, then the critical destabilizing change of pulse is minimized thereby. If the minimization of the relative height h₀ is combined with a peripheral introduction, then because of the maximized inlet width bᵢ with simultaneously optimized inlet height hᵢ, surprisingly no further entrainment into the inlet jet takes place. Thus in this case this results in a reduced volume flow in the main flow, so that the loading of the basin decreases, instead of increasing due to entrainment. Consequently the sedimentation basin can be of smaller construction or, in the case of predetermined size, can be more highly loaded.

Advantageous embodiments of the invention are set out in the subordinate claims.

If not only the relative height h₀ of the inlet but also the height hᵢ of the effective inlet cross-section can be varied, then depending upon the volume flow and/or density of the introduced suspension a destabilizing change in pulse in the region of the inlet can be prevented even more effectively.

A particularly advantageous construction of a peripheral inlet which can be adjusted in height is provided if the wall of the basin is broken by slots running all or part of the way around at least two levels and the inlet is controlled by means of closure devices so as to be adjustable in height in stages.

A further advantageous construction of a peripheral inlet which is adjustable in height is produced if at least two pipes which run all or part of the way around are disposed one above the other on the periphery of the basin, and feeding thereof can be distributed completely or partially to individual pipes using control and regulating techniques. The pipes must be capable of being flushed or scraped so that the suspension can be completely discharged in pipes which are temporarily not being supplied. Otherwise, for example in the case of biochemically active suspensions such as those flowing into secondary sedimentation basins, disadvantageous decomposition processes take place if the suspension remains for a long time in the inactive pipe.

The entrainment out of higher-density regions which has a positive effect on the flock filter action can be encouraged by means of a flow deflector above the inlet to ensure that entrainment into the incoming suspension flow can be supplied exclusively from the lower region of the sedimentation basin with suspension of a higher density. By means of an inclination of the flow deflector it is possible to limit the angle Φ at which the dense flow moves upwards. The entrainment is also controlled in this way. If one or more flow deflectors are constructed so that their angle Φ can be varied in operation, it is possible to control the entrainment variably for several static inlet heights and to guide the incoming dense flow in a controlled manner to the separation level.

Since the geometric shape of the surface has no qualitative influence on the physical phenomena which are relevant for the invention, it is possible for the surface of the sedimentation basin to be constructed in a round or rectangular shape. Special shapes of the basin surface are also possible.

Since the form of the extraction of the lighter phase has no qualitative influence on the phenomena which are relevant for the invention, the extraction of the lighter phase can take place in the form of weirs, open or immersed discharge pipes or other means.

Since the form of the extraction of the heavier phase also has no qualitative influence on the phenomena which are relevant for the invention, the extraction of the heavier phase can take place gravitationally with or without assistance from scrapers, with an inclined or horizontal floor of the sedimentation basin, by suction or by other means.

For reasons of construction and geometry it is possible that the separation level falls below the inlet surface at times in the case of very low loading of the sedimentation basin for an inlet height at the lowest adjustable point.

Embodiments of the invention are described in greater detail below with reference to the appended drawings, in which:

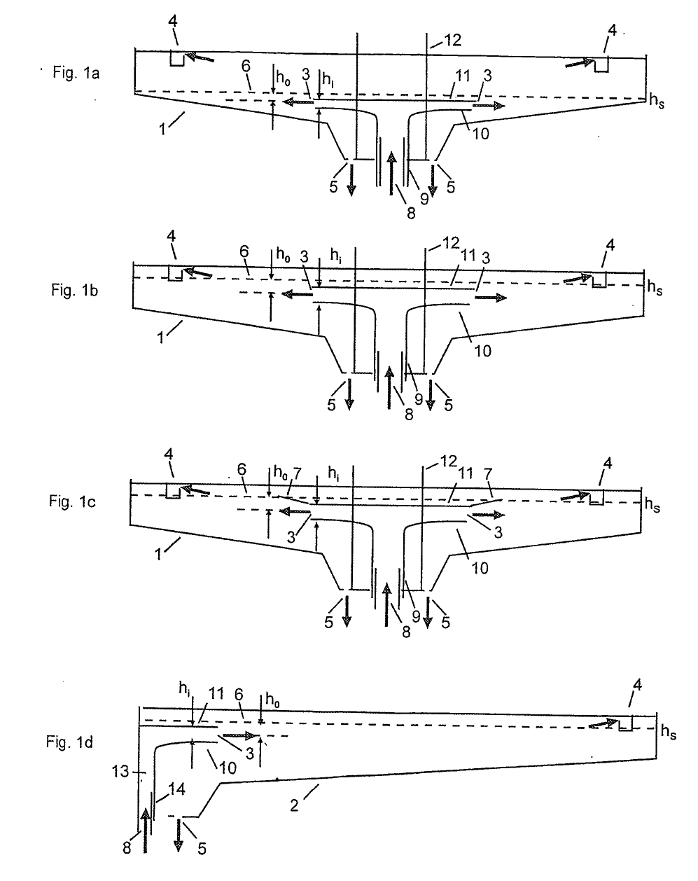

FIGS. 1a-1c show a round sedimentation basin with a central inlet construction, in its height adjustable inlet pipe and adjustable deflector plate;

FIG. 1d shows a rectangular sedimentation basin with a central inlet construction, a partition which is adjustable in height and adjustable deflector plate;

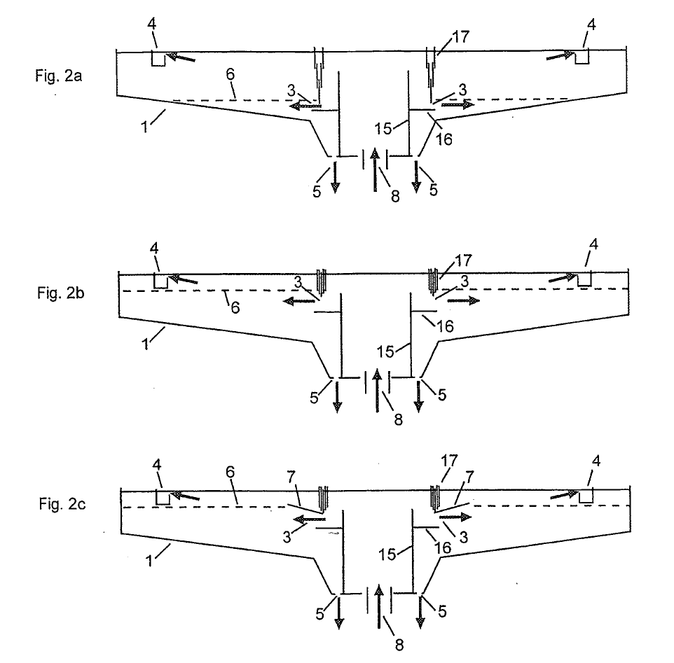

FIGS. 2a-2c show a round sedimentation basin with a central inlet construction, inlet pipe and telescopic pipe ring;

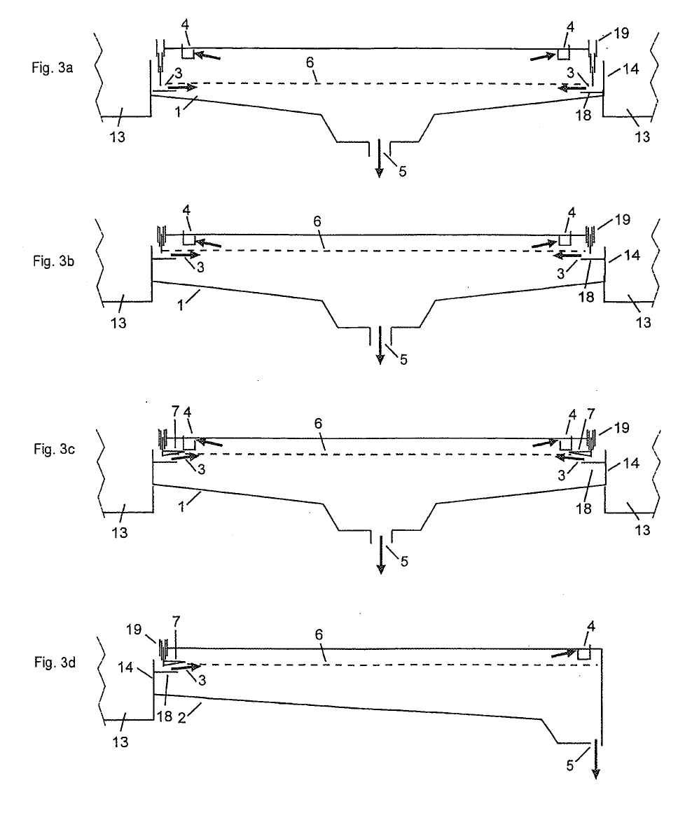

FIGS. 3a-3c show a round sedimentation basin with peripherally disposed intake basin, partition and telescopic boundary wall;

FIG. 3d shows a rectangular sedimentation basin with peripherally disposed intake basin, partition and telescopic boundary wall;

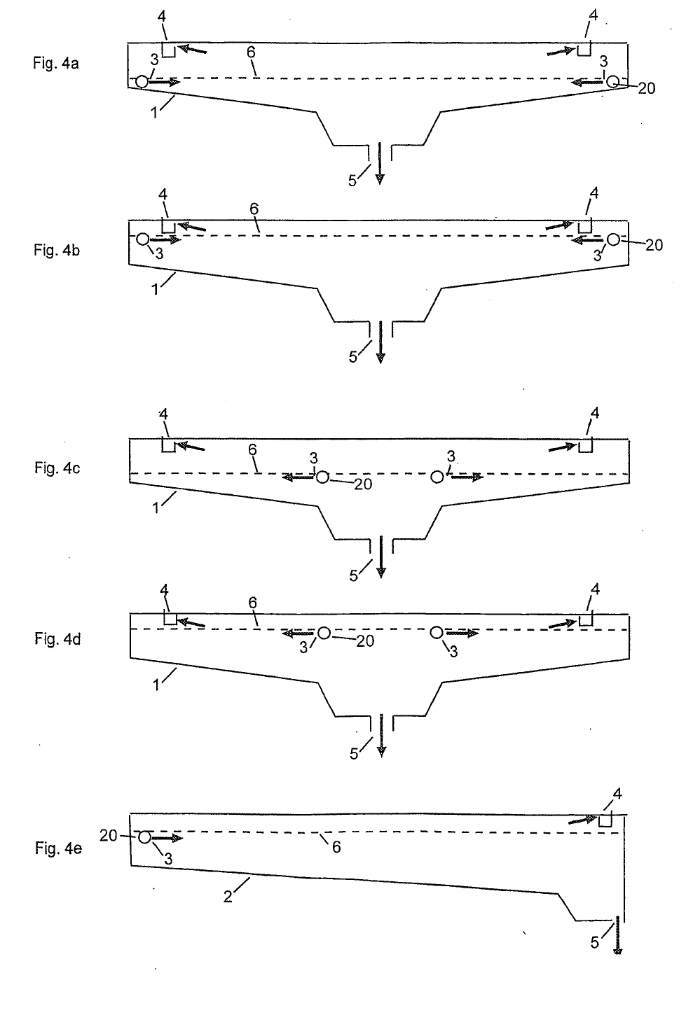

FIGS. 4a, 4b show a round sedimentation basin with peripherally disposed inlet conduit which is adjustable in height;

FIGS. 4c, 4d show a round sedimentation basin with centrally disposed inlet conduit which is adjustable in height;

FIG. 4e shows a rectangular sedimentation basin with inlet conduit which is adjustable in height disposed at the edge;

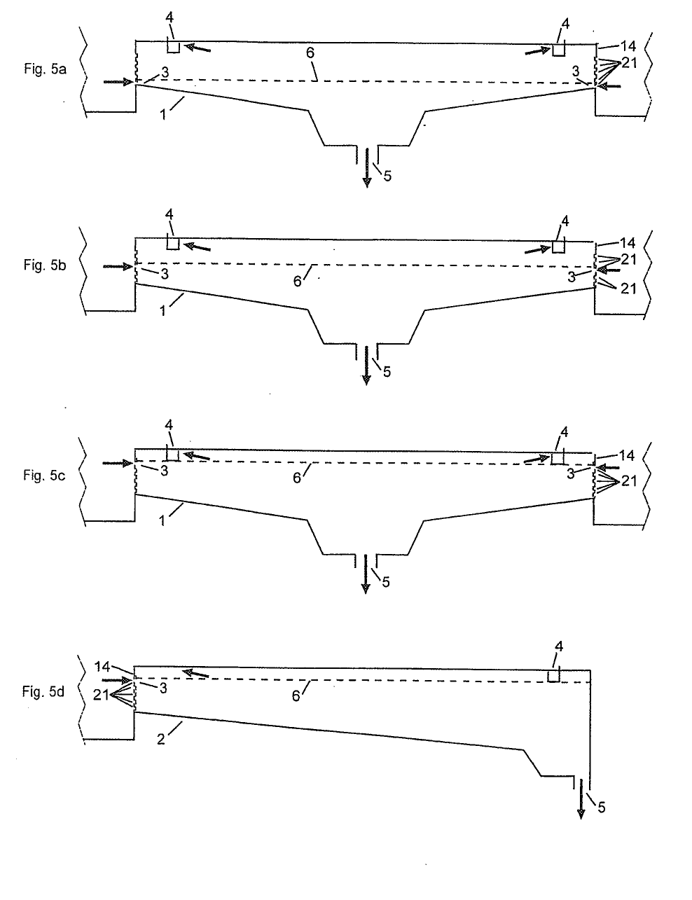

FIGS. 5a-5c show a round sedimentation basin with intake basin disposed at the edge and partition having slots;

FIG. 5d shows a rectangular sedimentation basin with intake basin disposed at the edge and partition having slots;

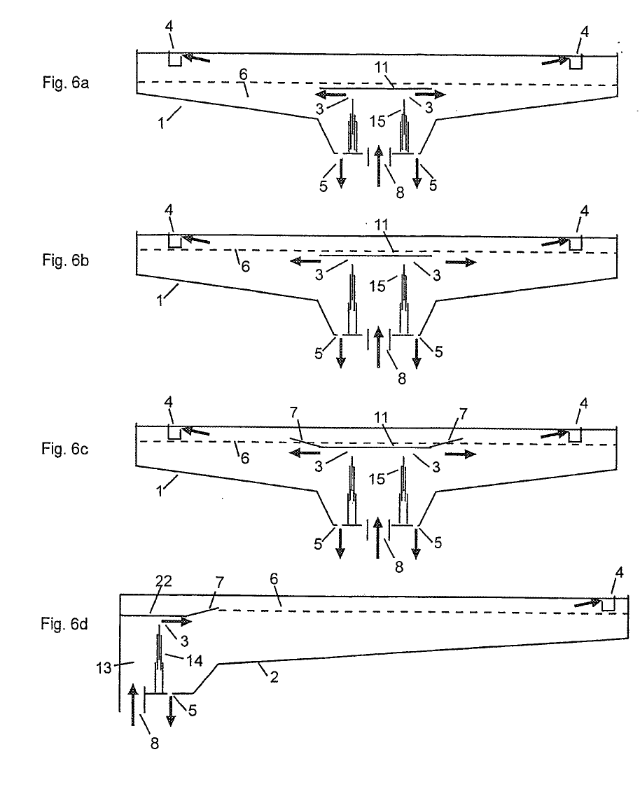

FIGS. 6a-6c show a round sedimentation basin with central inlet construction, telescopic inlet pipe and deflector plate which is adjustable in height;

FIG. 6d shows a rectangular sedimentation basin with intake basin disposed at the edge, telescopic partition and deflector plate;

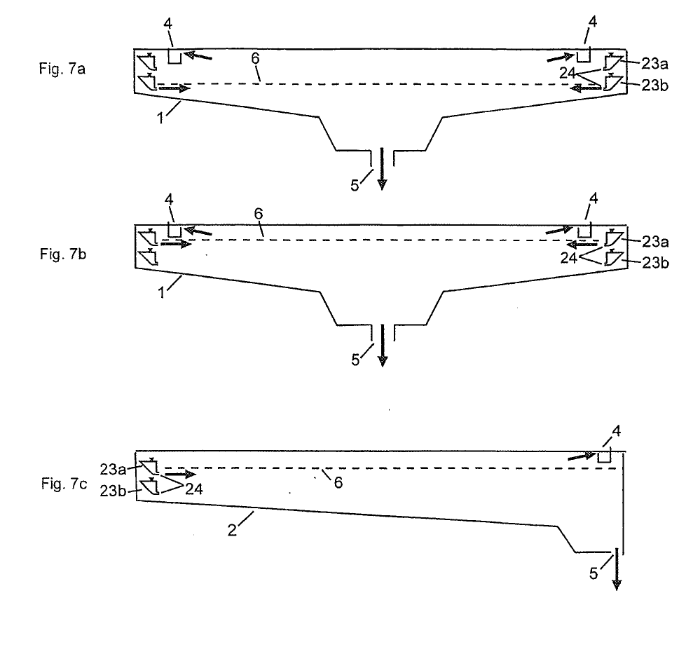

FIGS. 7a, 7b show a round sedimentation basin with two inlet conduits disposed one above the other at its edge;

FIG. 7c shows a rectangular sedimentation basin with two inlet conduits disposed one above the other at its edge.

All the drawings show sedimentation basins in highly simplified vertical sections. Similar elements are in each case denoted by the same reference numerals.

The round sedimentation basin which is shown by way of example in FIGS. 1a to 1c has a central inlet construction with an inlet 3 for a suspension of sewage sludge and water. The heavier sludge settles downwards, whilst clear water is in the upper part of the sedimentation basin 1. The clarified water is drawn off from the surface by a clear water extractor 4. The sludge which has settled downwards is drawn off at the deepest point of the sedimentation basin 1 by a sludge extractor 5. Between the heavy phase, that is to say the sludge, and the light phase, that is to say the clear water, a separation level 6 is formed. A flow deflector 7 mounted above the inlet 3 prevents entrainment from above.

The relative height h₀ of the inlet 3 is defined by the distance from the separation level 6. The cross-section of the inlet 3 has the height hᵢ. The suspension flows through the inlet 3 in a predominantly horizontal direction.

A suspension supply line 8 passes through the base of the sedimentation basin 1 and merges into a vertical intake pipe 9. The upper end of the intake pipe 9 merges constantly into a horizontal inlet surface 10. The intake pipe 9 is of telescopic construction, so that the height h₀ of the inlet can be continuously altered relative to the separation level 6. A deflector plate 11 is disposed above the inlet surface 10, parallel thereto and spaced therefrom. The deflector plate 11 can be moved upwards or downwards in the vertical direction by means of lifting rods 12. In this way the height hᵢ of the inlet cross-section can be changed as a function of the volume flow and/or the density of the introduced suspension.

In the rectangular sedimentation basin shown in FIG. 1d the inlet 3 is disposed on the left-hand edge. The suspension supply line 8 merges into an intake basin 13 which extends along the left-hand edge of the sedimentation basin 2. A partition 14 is disposed between the intake basin 13 and the sedimentation basin 2. The partition 14 merges at its upper edge into a horizontal inlet surface 10. A deflector plate 11 is disposed above the inlet surface 10, parallel thereto and at an adjustable distance therefrom. The distance between the inlet surface 10 and the underside of the deflector plate 11 defines the height hᵢ of the inlet cross-section. The partition 14 is designed to be adjustable in height, so that a continuous adaptation of the relative height h₀ of the inlet 3 to the respective height hₛ of the separation level 6 is achieved.

In the operational state illustrated in FIG. 1a the separation level 6 is relatively low down. The height h₀ of the inlet 3 is set correspondingly low. Furthermore in this operational state the inlet cross-section is kept relatively small due to the fact that the distance between the inlet surface 10 and the deflector plate 11 is relative small, resulting in a comparatively small height hᵢ of the inlet cross-section. By contrast, in FIG. 1b the separation level 6 is substantially higher. The height h₀ of the inlet 3 has been brought correspondingly upwards, so that the inlet 3 lies just below the height hₛ of the separation level. Also the height hᵢ of the inlet cross-section has been raised as the distance between the inlet surface 10 and the deflector plate 111 is increased.

The round sedimentation basin illustrated in FIGS. 2a to 2c has a centrally disposed inlet construction, comprising a suspension supply line 8 and an inlet 3 with continuously variable height. The suspension supply line 8 opens into an inlet pipe 15 of comparative large circumference. A concentric annular plate 16 is disposed so as to be adjustable in height on the outer wall of the inlet pipe 15. Above the annular plate 16 there is disposed a pipe ring 17 which surrounds the inlet pipe 15 concentrically in the region of its upper edge. The pipe ring 17 is of telescopic construction. The distance between the lower edge of the pipe ring 17 and the upper face of the annular plate 16 defines the inlet cross-section. Both the height of the inlet in relation to the separation level 6 and the height of the inlet cross-section are continuously adjustable.

FIGS. 3a to 3c show a construction which is similar in principle for a round sedimentation basin 2 with peripheral introduction. An intake basin 13 extends along the edge of the sedimentation basin 2. A partition 14 is disposed between the intake basin 13 and the sedimentation basin 2. A horizontal inlet plate 18 is disposed so as to be adjustable in height on the partition 14. A boundary wall 19 is provided above the inlet plate 18, spaced from and parallel to the partition 14. The boundary wall 19 is of telescopic construction. The distance between the lower edge of the boundary wall 19 and the upper face of the inlet plate 18 defines the height of the inlet cross-section.

As can be seen from a comparison of FIGS. 3a, 3b and 3c, by displacement of the inlet plate 18 and telescoping of the boundary wall 19 it is possible not only to adapt the relative height of the inlet 3 to different heights of the separation level 6 but also to adapt the height of the inlet cross-section.

FIG. 3d makes clear how a construction which is in principle the same can be provided in a rectangular sedimentation basin 2. Here the intake basin 13 is disposed on the left-hand edge of the sedimentation basin 2.

In the round sedimentation basin 1 according to FIGS. 4a and 4b the suspension supply line is connected to a horizontal annular inlet conduit 20, the wall (not shown) of which has outlet openings. The inlet conduit 20 extends along the edge of the sedimentation basin 1 and is adjustable in height.

In the constructions according to FIGS. 4c and 4d the inlet conduit 20 extends concentrically around the centre of the sedimentation basin 1.

If the sedimentation basin 2 is of rectangular construction, as shown in FIG. 4e, then the inlet conduit 20 extends parallel to the edge of the sedimentation basin 2.

In the round sedimentation basin according to FIGS. 5a to 5d the partition 14 has a plurality of slots 21 disposed one above the other. These slots 21 can be completely or partially opened and closed individually or in combination by closure elements (not shown). In this way the height of the inlet 3 can be adapted to different heights of the separation level 6.

In the embodiment according to FIGS. 6a, 6b and 6c the suspension supply line 8 opens into a central inlet pipe 15 which is of telescopic construction. A horizontal deflector plate 11 is disposed so as to be adjustable in height above the free upper end of the inlet pipe 15. The distance between the upper edge of the inlet pipe 15 and the underside of the deflector plate 11 defines the variable height of the cross-section of the inlet 3.

In the embodiment according to FIG. 6d the partition 14 is of telescopic construction between the rectangular sedimentation basin 2 and the intake basin 13. In this way the height of the partition 14 is adjustable. Towards the top the intake basin 13 is covered by a horizontal cover plate 22 which is adjustable in height and projects over the partition 14 to the sedimentation basin 2. The distance between the upper edge of the partition 14 and the underside of the cover plate 22 defines the variable height of the inlet cross-section. Since the cover plate 22 projects over the partition 14 it also serves to guide the flow, which can optionally be extended by an addition flow deflector 7.

According to FIGS. 7a and 7b a round sedimentation basin 1 can also have to inlet conduits 23a and 23b disposed one above the other on the periphery. Towards the interior, towards the centre of the sedimentation basin 1, the inlet conduits 23a, 23b have inlet slots 24 running round them through which the suspension runs in. Depending upon whether the separation level 6 is low (FIG. 7a) or high (FIG. 7b) the feed is through the lower inlet conduits 23b or the upper inlet conduits 23a.

In the rectangular sedimentation basin 2 according to FIG. 7c two inlet conduits 23a, 23b which are disposed one above the other extend along the outer edge of the sedimentation basin 2.

### LIST OF REFERENCE NUMERALS

1 round sedimentation basin
2 rectangular sedimentation basin
3 inlet
4 clear water extractor
5 sludge extractor
6 separation level
7 flow deflector
8 suspension supply line
9 inlet pipe
10 inlet surface
11 deflector plate
12 lifting rod
13 intake basin
14 partition
15 inlet pipe
16 annular plate
17 pipe ring
18 inlet plate
19 boundary wall
20 inlet conduit
21 slot (in 14)
22 cover plate
23a, 23b inlet conduits
24 inlet slot (in 23a, 23b)

1-18. (canceled)

19. A sedimentation basin system for a two-phase suspension in which the heavy phase settles downwards by gravitational separation and a separation level is formed between the heavy phase and the light phase, said sedimentation basing system comprising:
a centrally disposed inlet construction with at least one suspension supply line; and
at least one inlet which is adjustable in height and opens into said sedimentation basin in the region of the separation level, characterized in that said inlet has an inlet cross-section which is flowed through substantially horizontally and of which the relative height can be adapted continuously to the respective height of the separation level.

20. The sedimentation basin system as set fourth in claim 19, characterized by an arrangement for adjusting the height of said inlet cross-section as a function of the volume flow and/or the density of the introduced suspension.

21. The sedimentation basin system as set fourth in claim 20, characterized in that said suspension supply line comprises a substantially vertical inlet pipe which passes through the base of said sedimentation basin; said inlet pipe is constructed so as to be adjustable in height or telescopic; the upper end of said inlet pipe merges into a substantially horizontal inlet surface; a deflector plate is disposed above said inlet surface, parallel thereto and at an adjustable distance therefrom; and the distance between said inlet surface and said deflector defines the height of said inlet cross-section.

22. The sedimentation basin system as set fourth in claim 20, characterized in that said suspension supply line opens into an inlet pipe; a concentric annular plate is disposed so as to be adjustable in height on the outer wall of said inlet pipe; above said annular plate there is disposed a pipe ring which surrounds said inlet pipe of said suspension supply line concentrically at least in the region of its upper edge; said pipe ring is adjustable in height or of telescopic construction; and wherein the distance between the lower edge of said pipe ring and the upper face of said annular plate defines the height of said inlet cross-section.

23. The sedimentation basin system as set fourth in claim 20, characterized in that said suspension supply line opens into said inlet pipe; said inlet pipe is adjustable in height or of telescopic construction; a substantially horizontal deflector plate is disposed so as to be adjustable in height above the free end of said inlet pipe; the distance between the upper edge of said inlet pipe and the underside of said deflector plate defines the variable height of said inlet cross-section.

24. The sedimentation basin system as set fourth in claim 19, characterized in that said suspension supply line is connected to at least one inlet conduit which is adjustable in height, a wall of said inlet conduit having outlet openings; said inlet pipe extends concentrically around the center of said sedimentation basin.

25. The sedimentation basin system as set fourth in claim 19, characterized in that at least one flow deflector is disposed above said inlet.

26. The sedimentation basin system as set fourth in claim 25, characterized in that said flow deflector extends at an acute angle of inclination upwards in the direction of said separation level, wherein said angle of inclination of said flow deflector is adjustable.

27. A sedimentation basin system for a two-phase suspension, in which the heavy phase settles downwards by gravitational separation and a separation level is formed between the heavy phase and the light phase, said sedimentation basin system comprising:
a suspension supply line;
at least one inlet which is adjustable in height and opens into said sedimentation basin in the region of said separation level;
wherein said inlet is disposed in the region of the edge of said sedimentation basin; and
wherein the relative height of said inlet can be adapted to the respective height of said separation level.

28. The sedimentation basin system as set fourth in claim 27, characterized in that said suspension supply line comprises an intake basin which extends along at least a section of the edge of said sedimentation basin; a partition is disposed between said intake basin and said sedimentation basin.

29. The sedimentation basin system as set fourth in claim 28, characterized in that said partition is adjustable in height or is of telescopic construction; said partition merges at its upper edge into a horizontal inlet surface; a deflector plate is disposed above said inlet surface, parallel thereto and at an adjustable distance therefrom; the distance between said inlet surface and the underside of said deflector plate defines the height of said inlet cross-section.

30. The sedimentation basin system as set fourth in claim 28, characterized in that a substantially horizontal inlet plate is disposed so as to be adjustable in height on said partition; a boundary wall is provided above said inlet plate, spaced from and substantially parallel to said partition; said boundary wall is adjustable in height or of telescopic construction; the distance between the lower edge of said boundary wall and the upper face of said inlet plate defines the height of said inlet cross-section.

31. The sedimentation basin system as set fourth in claim 28, characterized in that said partition has a plurality of slots disposed one above the other; said slots can be completely or partially opened and closed individually or in combination by means of closure elements.

32. The sedimentation basin system as set fourth in claim 28, characterized in that the height of said partition is adjustable; towards the top said intake basin is covered by a horizontal cover plate which is adjustable in height; the distance between the upper edge of said partition and the underside of said cover plate defines the variable height of said inlet cross-section.

33. The sedimentation basin system as set fourth in claim 27, characterized by an inlet conduit which is adjustable in height and of which the wall has outlet openings.

34. The sedimentation basin system as set fourth in claim 27, characterized by at least two inlet conduits disposed one above the other, each with at least one inlet slot.

35. The sedimentation basin system as set fourth in claim 27, characterized in that at least one flow deflector is disposed above said inlet.

36. The sedimentation basin system as set fourth in claim 35, characterized in that said flow deflector extends at an acute angle of inclination upwards in the direction of said separation level.

37. The sedimentation basin system as set fourth in claim 36, characterized in that the angle of inclination of said flow deflector is adjustable.

38. The sedimentation basin system as set fourth in claim 37, characterized by an arrangement for controlling said angle of inclination of said flow deflector as a function of said relative height of said inlet.
